(19) United States
(12) Patent Application Publication
(10) Pub. No.: US 2022/0383616 A1
(43) Pub. Date: Dec. 1, 2022

(54) INFORMATION PROCESSING APPARATUS AND IMAGE PROCESSING METHOD

(71) Applicant: Hitachi High-Tech Corporation, Tokyo (JP)

(72) Inventors: Takato TATSUMI, Tokyo (JP); Kiyohiro OBARA, Tokyo (JP); Keisuke INATA, Tokyo (JP)

(73) Assignee: Hitachi High-Tech Corporation, Tokyo (JP)

(21) Appl. No.: 17/710,214

(22) Filed: Mar. 31, 2022

(30) Foreign Application Priority Data
May 27, 2021 (JP) 2021-089523

(51) Int. Cl. G06V 10/764; G06V 10/22

(52) U.S. Cl. CPC G06V 10/764; G06V 10/22

(57) ABSTRACT

An information processing apparatus includes an analysis target acquisition unit, an image processing unit, an inference unit, an inference result extraction unit, and a basis generation unit. The image processing unit generates a plurality of masked images by masking each of the images using a plurality of masks. The inference result extraction unit extracts an inference result at the target coordinates designated in the image from the inference result of each masked image. Based on the inference result at the target coordinates extracted by the inference result extraction unit and the plurality of masks, the basis generation unit generates a basis map visualizing the determination basis for the classification result of the image by the model.

### BACKGROUND OF THE INVENTION

### 1. Field of the Invention

The present invention relates to an information processing apparatus and an image processing method.

### 2. Description of the Related Art

In recent years, information processing apparatuses that perform image processing such as image recognition using machine learning have been widely used. An information processing apparatus using machine learning is required to improve reliability of recognition in addition to improvement of recognition accuracy.

Regarding improvement of reliability of image recognition by machine learning, for example, a technique of JP 6801751 B2 is known. JP 6801751 B2 discloses an information processing apparatus that includes a learned first neural network and a second neural network in which an initial value is set to a weight parameter, generates a mask on the basis of the second neural network, and updates either the first neural network or the second neural network on the basis of an evaluation result of an inference value based on combined data obtained by combining input data with the mask and the first neural network. As a result, the explanatory property of the neural network is improved while suppressing the accuracy degradation of the output by the neural network.

### SUMMARY OF THE INVENTION

JP 6801751 B2 describes that since the first neural network is a model that performs inference from outside the mask region, by visualizing a region of interest of this model, the region of interest can be grasped as a region used for inference. That is, by applying the technique of JP 6801751 B2, it is possible to indicate which part of the input image has been subjected to image classification by the neural network.

However, in the technology of JP 6801751 B2, although it is possible to visualize the region of interest of the inference model, it is not possible to indicate the basis of image classification in the entire image.

The present invention has been made in view of the above problems, and a main object thereof is to provide an information processing apparatus and an image processing method capable of indicating the basis of classification of images classified by image recognition using a model learned by machine learning, for the entire images.

An information processing apparatus according to the present invention includes: an analysis target acquisition unit configured to acquire an image to be analyzed; an image processing unit configured to set a plurality of masks for the image and generate a plurality of masked images by masking each of the images using the plurality of masks; an inference unit configured to perform inference using a learned model by machine learning for each of the plurality of masked images to acquire an inference result regarding classification of the image for each of the plurality of masked images; an inference result extraction unit configured to extract an inference result at target coordinates designated in the image from the inference result of each masked image acquired by the inference unit; and a basis generation unit configured to generate a basis map visualizing a determination basis for a classification result of the image by the model on a basis of the inference result at the target coordinates extracted by the inference result extraction unit and the plurality of masks.

An image processing method according to the present invention uses an information processing apparatus, including: acquiring an image to be analyzed; setting a plurality of masks for the image; generating a plurality of masked images by masking each of the images using the plurality of masks; acquiring, for each of the plurality of masked images, an inference result regarding classification of the image for each of the plurality of masked images by performing inference using a learned model by machine learning; extracting an inference result at target coordinates designated in the image from an inference result of each acquired masked image; and generating a basis map visualizing a determination basis for a classification result of the image by the model on a basis of the extracted inference result at the target coordinates and the plurality of masks.

According to the present invention, it is possible to provide an information processing apparatus and an image processing method capable of indicating the basis of classification of an image classified by image recognition using a model learned by machine learning for the entire image.

### BRIEF DESCRIPTION OF THE DRAWINGS

FIG. 1 is a block diagram illustrating a configuration example of an information processing apparatus according to a first embodiment of the present invention;

FIG. 2 is a flowchart illustrating an example of processing contents of the information processing apparatus according to the first embodiment of the present invention;

FIG. 3 is a diagram for explaining an example of mask processing;

FIG. 4 is a diagram for explaining an example of extraction of an inference result;

FIG. 5 is a diagram for explaining an example of basis map generation;

FIG. 6 is a flowchart illustrating an example of processing contents of an information processing apparatus according to a second embodiment of the present invention;

FIG. 7 is a diagram for explaining an example of basis map generation;

FIG. 8 is a flowchart illustrating an example of processing contents of an information processing apparatus according to a third embodiment of the present invention;

FIG. 9 is a block diagram illustrating a configuration example of an information processing apparatus according to a fourth embodiment of the present invention;

FIG. 10 is a flowchart illustrating an example of processing contents of the information processing apparatus according to the fourth embodiment of the present invention;

FIG. 11 is a diagram illustrating an example of an image in which a learning image is generated;

FIG. 12 is a diagram for explaining an example of template region determination; and

FIG. 13 is a diagram for explaining an example of learning image generation.

### DESCRIPTION OF THE PREFERRED EMBODIMENTS

Hereinafter, embodiments of the present invention will be described with reference to the drawings. The following description and drawings are exemplifications for describing the present invention, and are omitted and simplified as appropriate for clarification of the description. The present invention can be implemented in other various forms. Unless otherwise limited, each component may be singular or plural.

An example of an information processing apparatus of the present invention described in the following embodiments is used for supporting learning of an analysis device to which machine learning is applied. Examples of machine learning include learning of a neural network using learning data (teacher data). Such an information processing apparatus can be configured using a general computer such as a personal computer (PC) or a server. That is, the information processing apparatus according to the present invention includes an arithmetic processing device configured using a CPU, a ROM, a RAM, and the like, a storage device configured using a hard disk drive (HDD), a solid state drive (SSD), and the like, and various peripheral devices, similarly to a general PC or server. The program executed by the information processing apparatus is incorporated in the storage device in advance. In the following description, these components included in the information processing apparatus are not intentionally illustrated, and functions implemented in the information processing apparatus according to each embodiment will be focused and described.

Specifically, the functions of the information processing apparatus according to each embodiment are implemented by a program stored in a storage device and executed by an arithmetic processing device. That is, functions such as calculation and control described in each embodiment are implemented by software and hardware in cooperation with each other when a program stored in a storage device is executed by an arithmetic processing device. In the following description, a program executed by a computer or the like, a function thereof, or a means for realizing the function may be referred to as a “function”, a “means”, a “unit”, a “module”, or the like.

Note that the configuration of the information processing apparatus of each embodiment may be configured by a single computer or may be configured by a plurality of computers connected to each other via a network. The idea of the invention is equivalent and does not change.

In addition, in the information processing apparatus of each embodiment, the present invention is described with a function realized by software, but a function equivalent thereto can be realized by hardware such as a field programmable gate array (FPGA) or an application specific integrated circuit (ASIC). In addition, various types of software and hardware may be implemented in combination. These aspects are also included in the scope of the present invention.

### First Embodiment

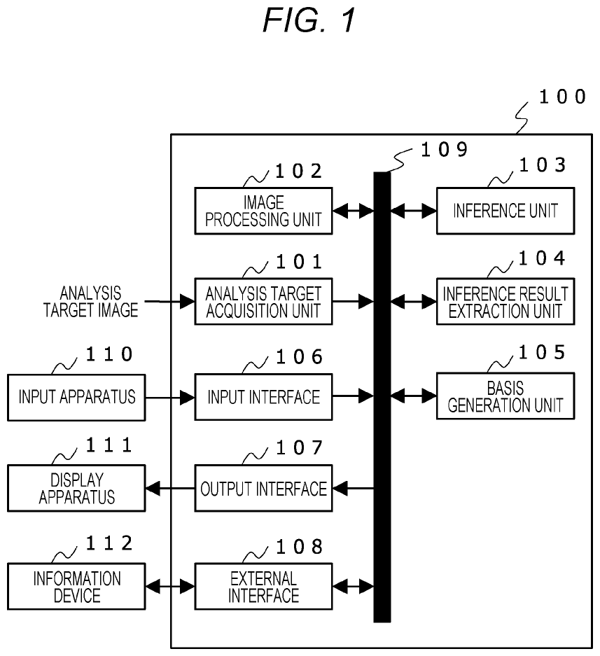

FIG. 1 is a block diagram illustrating a configuration example of an information processing apparatus 100 according to a first embodiment of the present invention. As illustrated in FIG. 1, the information processing apparatus 100 according to the present embodiment includes functional blocks of an analysis target acquisition unit 101, an image processing unit 102, an inference unit 103, an inference result extraction unit 104, a basis generation unit 105, an input interface 106, an output interface 107, and an external interface 108. These functional blocks are connected to each other via a bus 109. The bus 109 holds data, control information, analysis information, and the like handled by each functional block, and relays information transmission between the functional blocks.

As described at the beginning, each functional block in FIG. 1 is realized by software, hardware, or a combination thereof. The information processing apparatus 100 may include various types of hardware, interfaces, and the like normally included in a computer in addition to those illustrated in FIG. 1.

The information processing apparatus 100 is connected to an input apparatus 110, a display apparatus 111, and an information device 112. The information processing apparatus 100 may be connected to these components in a wired manner or in a wireless manner. Note that, although FIG. 1 illustrates an example in which the input apparatus 110 and the display apparatus 111 are provided outside the information processing apparatus 100, they may be incorporated in the information processing apparatus 100.

The analysis target acquisition unit 101 acquires an image to be analyzed by the information processing apparatus 100. This image may be, for example, an image selected by a user's input operation input from the input apparatus 110 via the input interface 106 among images stored in a storage device (not illustrated), or may be an image input from the external information device 112 via the external interface 108. Any image can be acquired by the analysis target acquisition unit 101 as long as the image can be classified by a learned model by machine learning and is an image to be analyzed by an analysis device (not illustrated).

The image processing unit 102 performs image processing using a mask on the image acquired by the analysis target acquisition unit 101 to generate a masked image. The image processing unit 102 can generate a plurality of masked images by setting a plurality of masks for one image and masking each image for each mask.

The inference unit 103 performs inference using a learned model by machine learning on each of the plurality of masked images generated from one image by the image processing unit 102. As a result, for each of the plurality of masked images, what the object shown in the image is can be determined, and the determination result can be acquired as an inference result regarding the classification of the original pre-masked image. Note that the classification of the image obtained by the inference performed by the inference unit 103 is hereinafter referred to as “class”. That is, the inference unit 103 can acquire the class representing the classification of each object as the inference result regarding the pre-masked image by determining the types of various objects shown in the masked image. In a case where there are a plurality of types of objects in the masked image, in a case where there is a background portion other than the objects in the masked image, or the like, a class corresponding to each of the image regions corresponding thereto is acquired for each image region as an inference result regarding the pre-masked image.

The inference result extraction unit 104 extracts an inference result at the target coordinates specified in the original pre-masked image from the inference result of each masked image acquired by the inference unit 103. Note that the target coordinates are designated by, for example, a user's input operation input from the input apparatus 110 via the input interface 106.

The basis generation unit 105 generates a basis map on the basis of the inference result at the target coordinates extracted by the inference result extraction unit 104 and the plurality of masks set when the image processing unit 102 generates the masked image. This basis map visualizes a determination basis for a classification result of an image executed using a learned model in an analysis device (not illustrated). A specific example of the basis map generated by the basis generation unit 105 will be described later.

The input interface 106 is connected to the input apparatus 110 and receives a user's input operation performed using the input apparatus 110. The input apparatus 110 is configured using, for example, a mouse, a keyboard, or the like. When the user inputs various instruction operations and selection operations to the information processing apparatus 100 using the input apparatus 110, the input operation content is transmitted to each functional block in the information processing apparatus 100 via the input interface 106. As a result, in each functional block, processing according to the user's input operation can be performed. For example, the analysis target acquisition unit 101 can acquire an image to be analyzed, target coordinates specified in the image, and the like on the basis of a user's input operation performed via the input interface 106.

The output interface 107 is connected to the display apparatus 111, outputs various images and information to the display apparatus 111, and causes the display apparatus 111 to display the contents thereof. The display apparatus 111 is configured using, for example, a liquid crystal display or the like. The information processing apparatus 100 can provide information to the user by causing the display apparatus 111 to display, for example, the basis map generated by the basis generation unit 105 via the output interface 107. At this time, the output interface 107 may display the basis map as is, or may display a screen in which the basis map is superimposed on the image to be analyzed.

The external interface 108 is connected to the external information device 112 and relays communication data transmitted and received between the information processing apparatus 100 and the information device 112. The information device 112 corresponds to, for example, a PC or a server existing in the same network as the information processing apparatus 100, a server existing on a cloud, or the like. The information processing apparatus 100 can acquire various information and data used in each functional block in the information processing apparatus 100 by receiving communication data from the information device 112 via the external interface 108. For example, the analysis target acquisition unit 101 can acquire an image to be analyzed, target coordinates specified in the image, and the like from the information device 112 via the external interface 108.

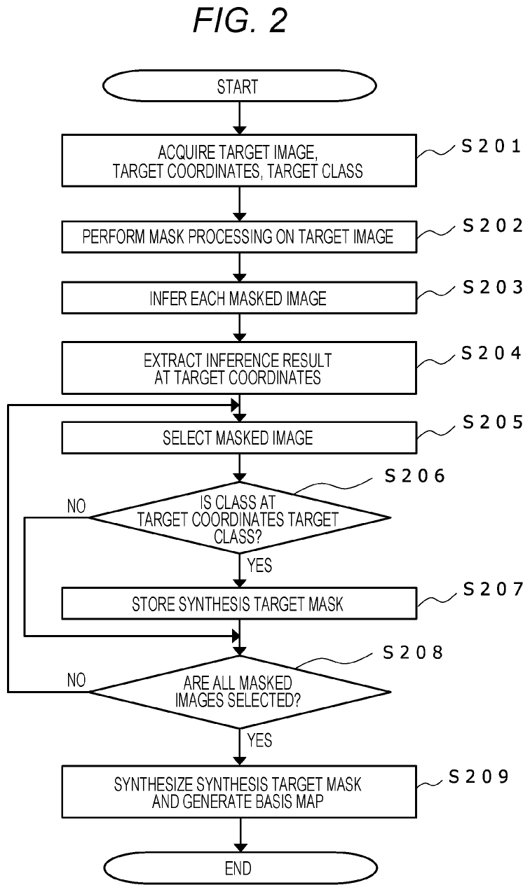

Next, a method for generating the basis map in the information processing apparatus 100 of the present embodiment will be described. FIG. 2 is a flowchart illustrating an example of processing contents of the information processing apparatus 100 according to the first embodiment of the present invention.

First, the analysis target acquisition unit 101 acquires an image to be analyzed, and acquires target coordinates and a target class in the target image (Step S201). Here, for example, as described above, the image to be analyzed and the target coordinates are acquired and the target class is acquired on the basis of information input from the input apparatus 110 or the external information device 112. The target class is a class designated as a generation target of the basis map among the above-described classes acquired by the inference unit 103 for each image region of the masked image. Similarly to the target coordinates, the target class can also be designated by a user's input operation input from the input apparatus 110 via the input interface 106, information input from the information device 112 via the external interface 108, or the like. In a case where the target coordinates and the target class are designated by a user's input operation, for example, the input operation may be a graphical input operation of displaying the target image on the display apparatus 111 and allowing the user to select the coordinates therein, or may be a character-based input operation. In addition to this, any input operation method can be adopted.

Note that, in the processing of Step S201, the target coordinates and the target class may be acquired on the basis of the information of the target image, the inference result of the inference unit 103 for the target image, and the like. For example, in a case where the contrast difference between the object shown in the target image and the background is small, the coordinates near the boundary may be acquired as the target coordinates. In addition, inference by the inference unit 103 may be performed on the target image in advance, and coordinates of a portion determined to be erroneous by presenting the inference result to the user, coordinates of a portion having a difference from an inference result obtained by another analysis method, or the like may be acquired as the target coordinates. Further, the classes of the image regions corresponding to these target coordinates may be acquired as the target class, or the classes corresponding to all the image regions in the target image may be acquired as the target class. In addition to this, the target coordinates and the target class can be acquired by an arbitrary method.

Next, the image processing unit 102 performs mask processing on the target image acquired in Step S201 to generate a masked image (Step S202). Here, for example, the target image is duplicated to generate a plurality of copy images, a separate mask is set for each copy image, and mask processing to which the mask set for each copy image is applied is performed, thereby generating a plurality of masked images. Note that each mask is divided into a processed portion (mask portion) and an unprocessed portion (non-mask portion), and in the process of Step S202, a portion corresponding to the processed portion in each copy image is masked. That is, in each copy image, the portion corresponding to the processed portion of the mask is subjected to predetermined image processing, and the portion corresponding to the unprocessed portion of the mask is used as is to generate the masked image.

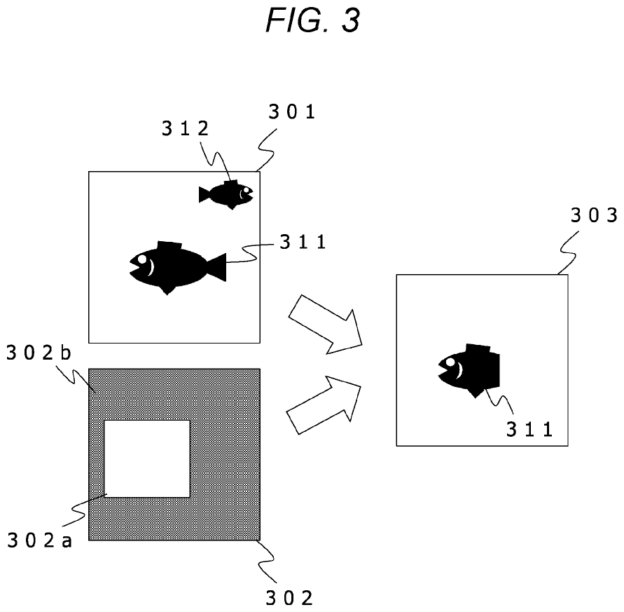

An example of the mask processing performed in Step S202 will be described with reference to FIG. 3. For example, a target image 301 is acquired as an image to be analyzed in Step S201, and a masked image 303 is generated by performing mask processing to apply a mask 302 to the image obtained by duplicating the target image 301 in Step S202. The target image 301 shows two fish 311 and 312, and the mask 302 has an unprocessed portion 302a and a processed portion 302b. In this case, in the masked image 303, masking processing is performed on a region corresponding to the processed portion 302b in the target image 301, and only a part of the fish 311 existing in the region corresponding to the unprocessed portion 302a remains.

Note that, in the processing of Step S202, the region overlapping the processed portion of the mask in the image obtained by copying the target image may be painted out with the background color of the target image, or may be painted out with a single color such as white or black. Alternatively, for example, a predetermined image filter such as a blurring filter may be applied. In addition to this, the mask processing can be performed using arbitrary image processing. In addition, the shape and number of masks set at the time of mask processing are not limited, and masks of various shapes such as circles and squares can be used. At this time, shapes of a plurality of types of masks may be mixed.

Further, in Step S202, the position of the mask may be randomly determined, or bias may be generated. As an example of providing a bias in the position of the mask, there is a method of providing a difference in the arrangement density of the masks by arranging many masks with the position of the target coordinates as a reference such that the boundary between the processed portion and the unprocessed portion of the mask comes near the target coordinates. Alternatively, it is possible to generate a bias in the positions of the masks by an arbitrary method such as generating many masks in the vicinity of a portion having a difference from the inference result obtained by another analysis method.

As described above, in the processing of Step S202, the image processing unit 102 can adjust at least one of the position, shape, and density of the plurality of masks set for the target image on the basis of the target coordinates or other coordinates specified in the target image.

Returning to the description of FIG. 2, the inference unit 103 performs inference on each of the plurality of masked images generated in Step S202 (Step S203). Here, the class of the object shown in each masked image is determined by performing inference using a learned model by machine learning for each masked image.

In Step S203, by the processing as described above, for each of the plurality of masked images generated in Step S202, the class representing the classification of the object determined using the learned model by the machine learning is acquired for each image region corresponding to the object and the background in each masked image as the inference result of the inference unit 103. Note that the inference result for each image region may be acquired in units of pixels in the image region, or may be acquired by thinning out an arbitrary number of pixels. Alternatively, one inference result may be acquired for each image region.

Subsequently, the inference result extraction unit 104 extracts an inference result at the target coordinates acquired in Step S201 from the inference result of each masked image acquired in Step S203 (Step S204). Here, by extracting the class of the image region corresponding to the target coordinates among the classes obtained for each image region for each masked image, it is possible to extract the inference result at the target coordinates.

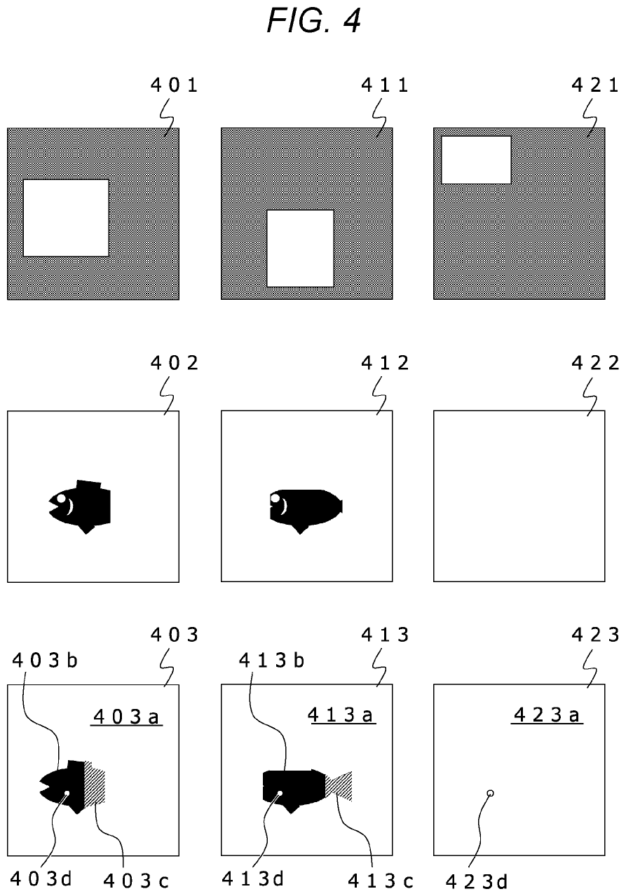

An example of extraction of an inference result performed in Step S204 will be described with reference to FIG. 4. For example, in Step S202, it is assumed that the masked images 402, 412, and 422 are generated by applying three masks 401, 411, and 421 to the target image 301 in FIG. 3. It is assumed that the class is acquired for each image region by the inference unit 103 inferring each of these masked images 402, 412, and 422 in Step S203. Note that, in order to simplify the description, in Step S203, a case where the inference unit 103 performs a semantic segmentation task of classifying each pixel on each masked image into three classes of “fish class”, “background class”, and “dog class” will be described. Here, generally, in the classification determination of the class, the reliability (score value) representing the certainty of the classification determination result is obtained in the range of 0 to 1 for each class, and the class having the maximum score value is acquired as the result of the classification determination.

Inference results 403, 413, and 423 in FIG. 4 represent the results of inference performed on each of the masked images 402, 412, and 422. In the inference results 403, 413, and 423, image regions 403a, 413a, and 423a have the highest score value of the background class in the masked images 402, 412, and 422, and thus represent the regions determined as the background class. Image regions 403b and 413b represent regions in which the score value of the fish class is the highest in the masked images 402 and 412 and thus are determined as the fish class, respectively. Each of image regions 403c and 413c represents a region in which the score value of the dog class is the highest in the masked images 402 and 412 and thus is determined as the dog class.

In addition, in the inference results 403, 413, and 423, coordinates indicated by reference numerals 403d, 413d, and 423d indicate the target coordinates acquired by the analysis target acquisition unit 101. The target coordinates 403d and 413d belong to the image regions 403b and 413b determined as the fish class as described above, respectively. Therefore, in the processing of Step S204, the fish class is extracted as the inference result at the target coordinates 403d and 413d. On the other hand, the target coordinates 423d belong to the image region 423a determined as the background class. Therefore, in the processing of Step S204, the background class is extracted as the inference result at the target coordinates 423d.

Returning to the description of FIG. 2, the basis generation unit 105 selects one of the plurality of masked images generated in Step S202 (Step S205).

Next, the basis generation unit 105 determines whether the inference result at the target coordinates extracted in Step S204 for the masked image selected in Step S205, that is, the class at the target coordinates matches the target class acquired in Step S201 (Step S206). When the class at the target coordinates of the selected masked image matches the target class, the basis generation unit 105 extracts the mask used to generate the masked image in Step S202 as a synthesis target mask, and temporarily stores the mask in a storage device (not illustrated) (Step S207). After performing the processing of Step S207, the basis generation unit 105 proceeds to next Step S208. On the other hand, when the class at the target coordinates of the selected masked image does not match the target class, the basis generation unit 105 proceeds to Step S208 without performing the processing of Step S207.

Subsequently, the basis generation unit 105 determines whether all the masked images have been selected in Step S205 (Step S208). If all the masked images generated in Step S202 have been selected, the process proceeds to Step S209, and if an unselected masked image remains, the process returns to Step S205. As a result, the processing of Steps S206 and S207 is performed on each masked image, and the mask whose class at the target coordinates matches the target class is stored as the synthesis target mask.

In the example of FIG. 4 described above, the following masks are stored as the synthesis target masks according to the target class by the processing of Steps S205 to S208. That is, in a case where the target class is the fish class, the masks 401 and 411 used when the masked images 402 and 412 in which the inference results 403 and 413 in which the inference result at the target coordinates 403d and 413d is the fish class is obtained is generated is stored as the synthesis target masks. In a case where the target class is the background class, the mask 421 used when the masked image 422 in which the inference result 423 in which the inference result at the target coordinates 423d is the background class is obtained is generated is stored as the synthesis target mask. In a case where the target class is the dog class, since there is no inference result in which the inference result at the target coordinates is the dog class in the inference results 403, 413, and 423, no mask is stored as the synthesis target mask.

Returning to the description of FIG. 2, the basis generation unit 105 generates a synthesis mask image by superimposing and synthesizing the respective synthesis target masks stored in Step S207, and generates a basis map on the basis of the synthesis mask image (Step S209). Here, for example, when all the synthesis target masks are superimposed, the ratio of the number of superimpositions of the unprocessed portions (non-mask portions) to the total number is obtained to calculate a basis rate for each region. Then, the basis map is generated by visualizing the obtained basis rate of each region.

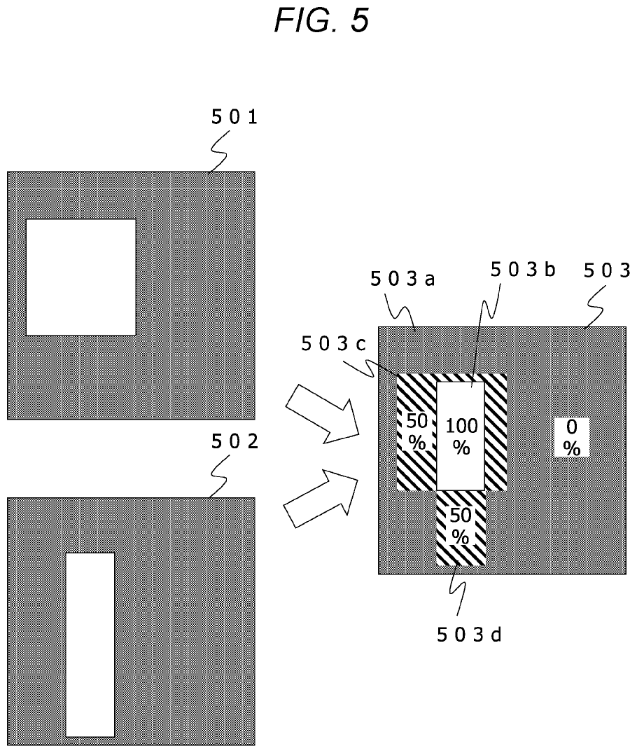

An example of basis map generation performed in Step S209 will be described with reference to FIG. 5. For example, in a case where the two masks 501 and 502 are stored as the synthesis target mask in Step S207, a basis map 503 is generated by superimposing these two masks.

The basis map 503 has regions 503a, 503b, 503c, and 503d. In the region 503a, the processed portions (mask portion) of the masks 501 and 502 are superimposed, and the basis rate in this region 503a is calculated as 0/2=0%. In the region 503b, the unprocessed portions of the masks 501 and 502 are superimposed, and the basis rate in this region 503b is calculated as 2/2=100%. In the regions 503c and 503d, one processed portion and the other unprocessed portion of the masks 501 and 502 are superimposed, and the basis rate in the regions 503c and 503d is calculated as 1/2=50%.

When the generation of the basis map is completed in Step S209, the information processing apparatus 100 of the present embodiment completes the flowchart of FIG. 2.

Note that the generated basis map is presented to the user by being displayed on the display apparatus 111 via the output interface 107, for example. At this time, the display apparatus 111 changes the display form (for example, color, brightness, or the like) of the basis map for each region according to the value of the basis rate described above, for example. As a result, it is possible to indicate to the user the grounds of classification of the entire target image classified by the image recognition using the model learned by the machine learning. At this time, the basis map may be superimposed and displayed on the target image so as to facilitate comparison with the target image. In addition, target coordinates may be indicated on the basis map.

According to the first embodiment of the present invention described above, the following operational advantages are achieved.

(1) The information processing apparatus 100 includes the analysis target acquisition unit 101 that acquires an image to be analyzed, the image processing unit 102 that generates a plurality of masked images by setting a plurality of masks for the image and masking the image using the plurality of masks, the inference unit 103 that performs inference using a learned model by machine learning for each of the plurality of masked images to acquire an inference result regarding classification of the image for each of the plurality of masked images, the inference result extraction unit 104 that extracts an inference result at target coordinates designated in the image from the inference result of each masked image acquired by the inference unit 103, and the basis generation unit 105 that generates a basis map visualizing a determination basis for the classification result of the image by the model on the basis of the inference result at the target coordinates and the plurality of masks extracted by the inference result extraction unit 104. With this configuration, it is possible to provide the information processing apparatus 100 capable of indicating the grounds of classification of images classified by image recognition using a model learned by machine learning as a whole.

(2) The inference unit 103 acquires, for each of the plurality of masked images, a class representing the classification of the image determined by the inference for each image region as the inference result (Step S203). The inference result extraction unit 104 extracts the class of the image region corresponding to the target coordinates among the classes for each image region of each masked image acquired by the inference unit 103 (Step S204). For each masked image in which the class extracted by the inference result extraction unit 104 matches the target class designated for the image among the plurality of masked images, the basis generation unit 105 extracts the mask used for generating the masked image as the synthesis target mask (Steps S206 and S207), generates the synthesis mask image by superimposing and synthesizing the extracted synthesis target masks, and generates the basis map on the basis of the generated synthesis mask image (Step S209). With this configuration, for an arbitrary target class, the basis map indicating the basis that the target class is obtained as the classification result of the image can be generated.

(3) The information processing apparatus 100 includes an input interface 106 that accepts a user's input operation. The analysis target acquisition unit 101 can acquire the target coordinates on the basis of the user's input operation performed via the input interface 106 (Step S201). In this way, the basis map can be generated for arbitrary target coordinates specified by the user.

(4) The information processing apparatus 100 includes the output interface 107 that is connected to the display apparatus 111 and provides information to the user by causing the display apparatus 111 to display the basis map. With this configuration, the information provision regarding the classification basis of the image can be provided to the user in an easy-to-understand manner using the basis map.

(5) The output interface 107 can also cause the display apparatus 111 to display a screen in which the basis map is superimposed on the image to be analyzed. In this way, it is possible to provide information to the user in a form in which the image to be analyzed and the basis map can be easily compared.

(6) The information processing apparatus 100 includes the external interface 108 connected to the external information device 112. The analysis target acquisition unit 101 can also acquire target coordinates via the external interface 108 (Step S201). In this way, it is possible to generate the basis map for the target coordinates designated using the inference result or the like obtained by another analysis method.

(7) The image processing unit 102 can adjust at least one of the position, shape, and density of the plurality of masks set for the image on the basis of the target coordinates or other coordinates specified in the image (Step S202). In this way, it is possible to automatically acquire a plurality of masks necessary for generating the basis map for the image to be analyzed in an appropriate manner.

(8) The image processing unit 102 generates a masked image using an unmasked portion of the image as is, and performs predetermined image processing on a masked portion of the image to generate a masked image (Step S202). With this configuration, the masked image can be easily generated from the image to be analyzed.

### Second Embodiment

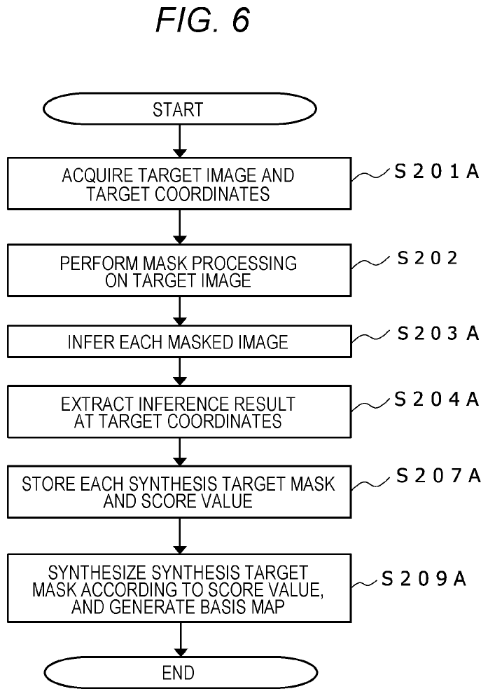

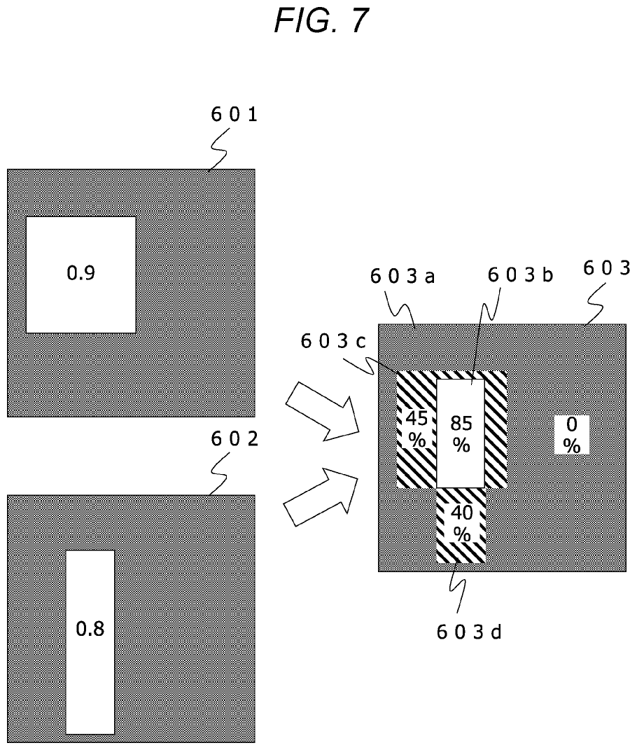

Next, an information processing apparatus according to a second embodiment of the present invention will be described with reference to FIGS. 6 and 7. Note that the information processing apparatus of the present embodiment has the same configuration as the information processing apparatus 100 of FIG. 1 described in the first embodiment. Therefore, the present embodiment will be described below using the configuration of the information processing apparatus 100 in FIG. 1.

Hereinafter, a method for generating a basis map in the information processing apparatus 100 according to the present embodiment will be described. FIG. 6 is a flowchart illustrating an example of processing contents of the information processing apparatus 100 according to the second embodiment of the present invention. Note that, in the flowchart of FIG. 6, the same step numbers as those in FIG. 2 are assigned to portions that perform processing similar to that in the flowchart of FIG. 2 described in the first embodiment. Hereinafter, description of the processing with the same step number will be omitted.

The analysis target acquisition unit 101 acquires an image to be analyzed and also acquires target coordinates in the target image (Step S201A). In the present embodiment, unlike the first embodiment, the target image and the target coordinates are acquired, but it is not necessary to acquire the target class.

After the processing of Step S202 is executed by the image processing unit 102, the inference unit 103 performs inference on each of the plurality of masked images generated in Step S202 (Step S203A). Here, similarly to the first embodiment, the class of the object shown in each masked image is determined by performing inference using a learned model by machine learning for each masked image. Further, in the present embodiment, a score value representing the reliability for the class determined for each object for each masked image is calculated. This score value changes according to the learning degree of the model used in the inference by the inference unit 103, and generally becomes a higher score value as the learning of the model progresses.

Next, the inference result extraction unit 104 extracts each inference result at the target coordinates acquired in Step S203A from the inference result of each masked image acquired in Step S201A (Step S204A). Here, by extracting the score value of the image region corresponding to the target coordinates among the score values obtained for each image region for each masked image, it is possible to extract the inference result at the target coordinates.

Subsequently, the basis generation unit 105 sets each mask used to generate the masked image in Step S202 as a synthesis target mask, and temporarily stores the mask in a storage device (not illustrated) in combination with the inference result at the target coordinates extracted in Step S204A, that is, the score value at the target coordinates (Step S207A).

Thereafter, the basis generation unit 105 weights each of the synthesis target masks stored in Step S207A at a ratio according to the score value, and superimposes and synthesizes these to generate a synthesis mask image. The basis map is generated on the basis of the synthesis mask image generated in this manner (Step S209A). That is, weighting values corresponding to the score values are set for the unprocessed portions (non-masked portions) in all the masks, and the weighting values of the unprocessed portions overlapping each other when the masks are superimposed are summed and divided by the number of masks to calculate the basis coefficient for each region. Then, the basis map is generated by visualizing the obtained basis coefficient of each region.

An example of basis map generation performed in Step S209A will be described with reference to FIG. 7. For example, in a case where two masks 601 and 602 are stored as the synthesis target mask in Step S207A, a basis map 603 is generated by superimposing these two masks. For example, the score value 0.9 extracted in Step S204A is set as a weighting value in the unprocessed portion of the mask 601, and the score value 0.8 extracted in Step S204A is set as a weighting value in the unprocessed portion of the mask 602.

The basis map 603 has regions 603a, 603b, 603c, and 603d. In the region 603a, the processed portions (mask portions) of the masks 601 and 602 is superimposed, and the basis coefficient in this region 603a is calculated as (0×0.9+0×0.8)/2=0%. In the region 603b, the unprocessed portions of the masks 601 and 602 are superimposed, and the basis coefficient in this region 603b is calculated as (1×0.9+1×0.8)/2=85%. In the region 603c, the unprocessed portion of the mask 601 and the processed portion of the mask 602 are superimposed, and the basis coefficient in this region 603c is calculated as (1×0.9+0×0.8)/2=45%. In the region 603d, the processed portion of the mask 601 and the unprocessed portion of the mask 602 are superimposed, and the basis coefficient in this region 603d is calculated as (0×0.9+1×0.8)/2=40%.

When the generation of the basis map is completed in Step S209A, the information processing apparatus 100 of the present embodiment completes the flowchart of FIG. 6.

According to the second embodiment of the present invention described above, the inference unit 103 acquires, for each of the plurality of masked images, the score value representing the reliability of the inference for the classification of the target image for each image region as the inference result (Step S203A). The inference result extraction unit 104 extracts the score value of the image region corresponding to the target coordinates among the score values for each image region of each masked image acquired by the inference unit 103 (Step S204A). The basis generation unit 105 generates a synthesis mask image by superimposing and synthesizing a plurality of masks at a ratio according to the score value extracted by the inference result extraction unit 104, and generates a basis map on the basis of the generated synthesis mask image (Step S209A). With this configuration, it is possible to generate the basis map indicating the basis obtained as the classification result of the images for all the classes.

### Third Embodiment

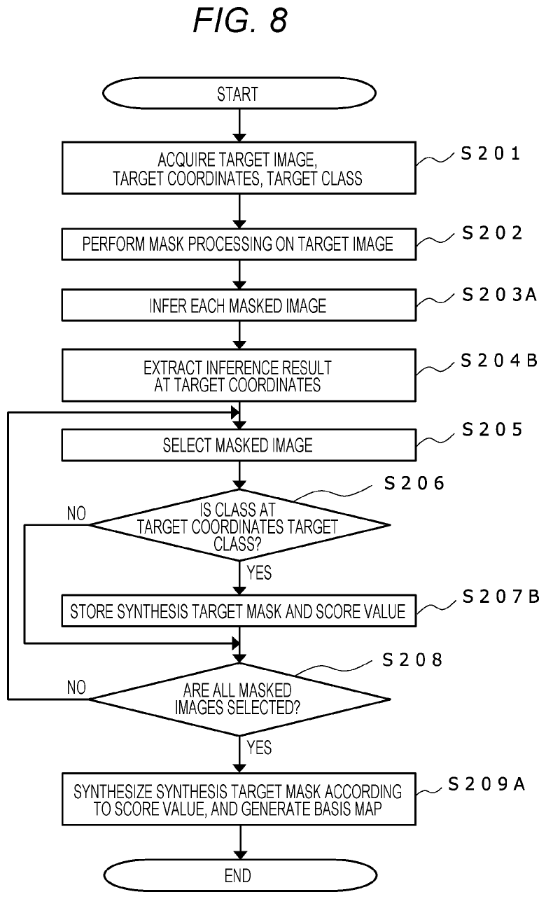

Next, an information processing apparatus according to a third embodiment of the present invention will be described with reference to FIG. 8. Note that the information processing apparatus of the present embodiment also has the same configuration as the information processing apparatus 100 of FIG. 1 described in the first embodiment, similarly to the second embodiment described above. Therefore, the present embodiment will be described below using the configuration of the information processing apparatus 100 in FIG. 1.

Hereinafter, a method for generating a basis map in the information processing apparatus 100 according to the present embodiment will be described. FIG. 8 is a flowchart illustrating an example of processing contents of the information processing apparatus 100 according to the third embodiment of the present invention. Note that, in the flowchart of FIG. 8, the same step numbers as those in FIGS. 2 and 6 are assigned to portions that perform processing similar to that in the flowcharts of FIGS. 2 and 6 described in the first and second embodiments, respectively.

First, similarly to the first embodiment, analysis target acquisition unit 101 acquires an image to be analyzed, and acquires target coordinates and a target class in the target image (Step S201). Next, as in the first embodiment, the image processing unit 102 performs mask processing on the target image acquired in Step S201 to generate a masked image (Step S202). Thereafter, the inference unit 103 performs inference on each of the plurality of masked images generated in Step S202 (Step S203A). Here, similarly to the second embodiment, the class of the object shown in each masked image is determined, and the score value is calculated.

Next, the inference result extraction unit 104 extracts each inference result at the target coordinates acquired in Step S203A from the inference result of each masked image acquired in Step S201 (Step S204B). Here, by extracting the class and the score value of the image region corresponding to the target coordinates among the classes and the score values obtained for each image region for each masked image, it is possible to extract the inference result at the target coordinates.

Subsequently, similarly to the first embodiment, the basis generation unit 105 selects one of the plurality of masked images generated in Step S202 (Step S205), and determines whether a class at the target coordinates extracted in Step S204B for the selected masked image matches the target class acquired in Step S201 (Step S206). As a result, when the class at the target coordinates of the selected masked image matches the target class, the basis generation unit 105 extracts the mask used to generate the masked image in Step S202 as a synthesis target mask, and temporarily stores the mask in a storage device (not illustrated) in combination with the score value at the target coordinates extracted in Step S204B (Step S207B). After performing the processing of Step S207B, the basis generation unit 105 proceeds to next Step S208. On the other hand, when the class at the target coordinates of the selected masked image does not match the target class, the basis generation unit 105 proceeds to Step S208 without performing the processing of Step S207B.

Subsequently, the basis generation unit 105 determines whether all the masked images have been selected in Step S205 (Step S208). If all the masked images generated in Step S202 have been selected, the process proceeds to Step S209A, and if an unselected masked image remains, the process returns to Step S205. As a result, the processing of Steps S206 and S207B is performed on each masked image, and the mask whose class at the target coordinates matches the target class is stored as the synthesis target mask together with the score value.

The basis generation unit 105 generates a synthesis mask image by superimposing and synthesizing the respective synthesis target masks stored in Step S207B, and generates a basis map on the basis of the synthesis mask image (Step S209A). Here, similarly to the second embodiment, each synthesis target mask saved in Step S207B is weighted at a ratio according to the score value, and these are superimposed and synthesized to generate a synthesis mask image. The basis map is generated on the basis of the synthesis mask image in this manner.

When the generation of the basis map is completed in Step S209A, the information processing apparatus 100 of the present embodiment completes the flowchart of FIG. 8.

According to the third embodiment of the present invention described above, the inference unit 103 further acquires a score value representing the reliability of inference for the classification of the target image for each class as the inference result for each of the plurality of masked images (Step S203A). The inference result extraction unit 104 extracts a class and a score value corresponding to the target coordinates of each masked image acquired by the inference unit 103 (Step S204B). The basis generation unit 105 superimposes and synthesizes each synthesis target mask at a ratio according to the score value extracted by the inference result extraction unit 104 to generate a synthesis mask image (Step S209A). With this configuration, it is possible to generate the basis map indicating a more detailed basis for an arbitrary target class.

Note that the first to third embodiments described above may be set in advance in the information processing apparatus 100, or may be arbitrarily selectable by the user by an input operation input from the input apparatus 110 via the input interface 106. For example, in Step S201 in FIGS. 2 and 8 or Step S201A in FIG. 6, when the target image, the target coordinates, and the target class are acquired according to the user's input operation, the user is allowed to select the method for generating the basis map, whereby which embodiment is applied can be determined.

### Fourth Embodiment

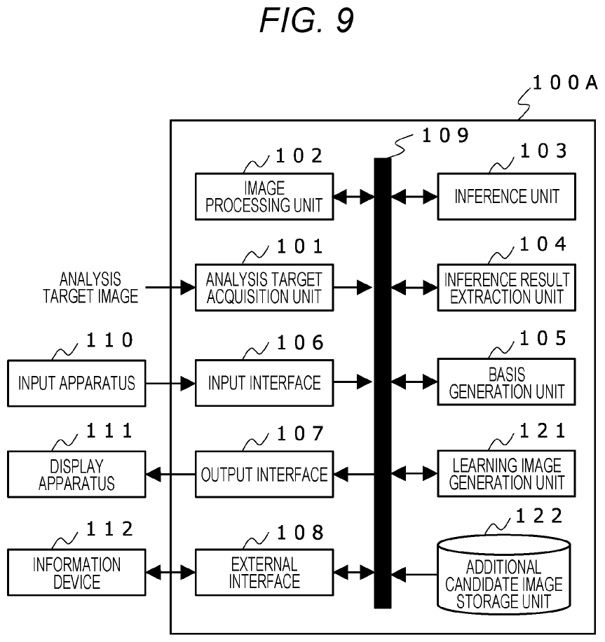

Next, an information processing apparatus according to a fourth embodiment of the present invention will be described with reference to FIGS. 9 to 13.

FIG. 9 is a block diagram illustrating a configuration example of an information processing apparatus 100A according to the fourth embodiment of the present invention. As illustrated in FIG. 9, the information processing apparatus 100A according to the present embodiment further includes a learning image generation unit 121 and an additional candidate image storage unit 122 in addition to each element of the information processing apparatus 100 according to the first embodiment illustrated in FIG. 1. The learning image generation unit 121 is realized, for example, by executing a predetermined program by the CPU, and the additional candidate image storage unit 122 is configured using a storage device such as an HDD or an SSD.

The learning image generation unit 121 generates a learning image used for machine learning of a model. This model is used for classification of images in an analysis device (not illustrated), and is also used for inference performed by the inference unit 103. The learning image generated by the learning image generation unit 121 is input to, for example, a learning device (not illustrated) and used in machine learning of a model performed by the learning device. Note that a machine learning unit may be provided in the information processing apparatus 100A, and the machine learning unit may perform machine learning of the model.

The additional candidate image storage unit 122 stores one or a plurality of additional candidate images registered in advance. Each additional candidate image stored in the additional candidate image storage unit 122 is, for example, an image in which an object same as or similar to an object to be analyzed by the analysis device is captured, and is used when the learning image generation unit 121 generates a learning image. That is, the learning image generation unit 121 can generate a learning image for machine learning on the basis of the additional candidate image stored in the additional candidate image storage unit 122.

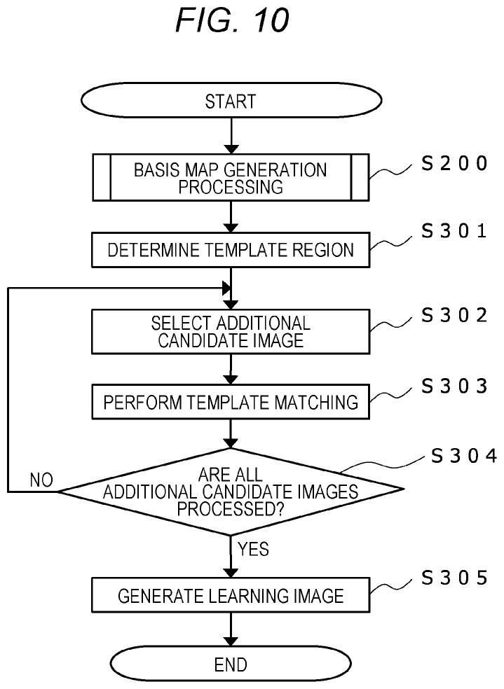

FIG. 10 is a flowchart illustrating an example of processing contents of the information processing apparatus 100A according to the fourth embodiment of the present invention.

In Step S200, basis map generation processing is executed. Here, the basis map is generated for the target image according to any one of the flowcharts of FIGS. 2, 6, and 8 described in the first to third embodiments. In the information processing apparatus 100A of the present embodiment, the learning image is generated using the basis map.

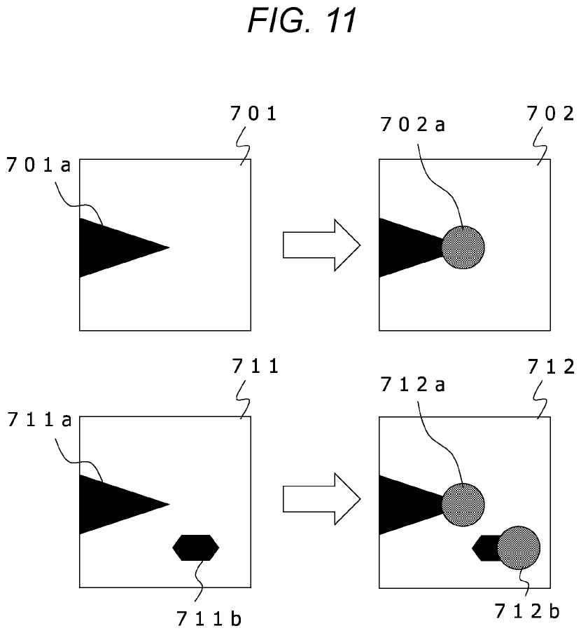

FIG. 11 is a diagram illustrating an example of an image in which a learning image is generated in the information processing apparatus 100A of the present embodiment. In the present embodiment, an example of generating a learning image in order to improve the accuracy of analysis processing performed in an analysis device (not illustrated) will be described.

Images 701 and 711 in FIG. 11 are examples of images captured by an electron microscope in the process of semiconductor inspection. The analysis device executes a task of recognizing the tip portions of needles 701a and 711a shown in these images using semantic segmentation. Here, while only the needle 701a to be detected is shown in the image 701, a dirt 711b not to be detected is shown in addition to the needle 711a to be detected in the image 711. Note that it is assumed that the semantic segmentation model has already been learned in advance using predetermined learning data in the analysis device.

When the execution results of the tasks by the analysis device are superimposed on the images 701 and 711, for example, inference results 702 and 712 are obtained. In the inference results 702 and 712, circles 702a and 712a are drawn around the recognized tip portions of the needles 701a and 711a, respectively. In addition, in the inference result 712, the tip portion of the dirt 711b is also erroneously recognized as the tip portion of the needle, so that a circle 712b is drawn.

Here, the task executed on the images 701 and 711 aims to recognize the tip portion of the needle and determine the other portion as the background class. However, in the inference results 702 and 712 of FIG. 11, only the portion recognized as the tip portion of the needle is indicated by a circle, and the background class is not explicitly indicated because the range is wide. In the example of FIG. 11, the inference result 702 is ideal because the circle 702a is correctly drawn around the tip of the needle 701a, and the other portion can be determined as the background class. On the other hand, the inference result 712 is not preferable because the circle 712a is correctly drawn around the tip of the needle 711a, but the circle 712b is also incorrectly drawn for the dirt 711b.

In the information processing apparatus 100A of the present embodiment, for example, an image estimated to have a high effect of suppressing such erroneous recognition of the dirt 711b is selected, and a learning image is generated using the image. The generated learning image is provided from the information processing apparatus 100A to a learning device (not illustrated), and is used in the machine learning of the model performed by the learning device.

Returning to the description of FIG. 10, the learning image generation unit 121 determines a template region based on the basis map generated by the basis map generation processing in Step S200 (Step S301). For example, a part of the target image used to generate the basis map is extracted as the template region based on the distribution of basis degrees (basis rates or basis coefficients) of the classification result on the target image indicated by the basis map. Specifically, for example, a threshold of the basis degree is set for the basis map, and a region of the target image corresponding to a region of the basis map having a larger value of the basis degree than the threshold is extracted as the template region.

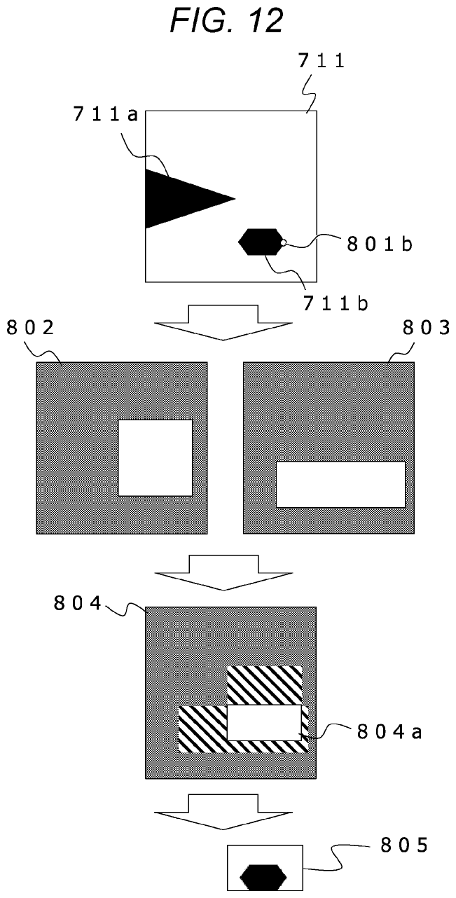

An example of the template region determination performed in Step S301 will be described with reference to FIG. 12. An image 711 illustrated in FIG. 12 is the same as the image 711 illustrated in FIG. 11. When the image 711 is set as the target image, the tip portion of the dirt 711b is designated as target coordinates 801b, and the basis map generation processing in Step S209 is executed, for example, masks 802 and 803 are set, and a basis map 804 is generated by superimposing these masks. In the processing of Step S301, for example, when the threshold is set to 80% with respect to the basis map 804, a region 804a in which the basis degree exceeds the threshold 80% is selected, and a region 805 of the image 711 corresponding to the region 804a is extracted as the template region. The template region 805 thus extracted includes the dirt 711b for which the target coordinates 801b are designated.

Note that the threshold at the time of determining the template region in Step S301 may be designated according to a user's input operation input from the input apparatus 110 via the input interface 106, for example, or may be automatically designated by the information processing apparatus 100A with reference to a quartile, an average value, or the like of the basis degree in the entire basis map. The size and shape of the template region can be arbitrarily set. For example, a portion where the basis degree satisfies the threshold in the basis map may be set as the template region in units of pixels, or a region such as a rectangle or a circle having a size sufficient to include the pixels may be set as the template region.

Returning to the description of FIG. 10, the learning image generation unit 121 selects one of the additional candidate images stored in the additional candidate image storage unit 122 (Step S302). Subsequently, the learning image generation unit 121 performs template matching for the additional candidate image selected in Step S302 using the template region determined in Step S301 (Step S303). Here, for example, a portion having the highest similarity to the template region in the additional candidate image is determined, and the similarity of the portion is extracted as a matching result.

In the template matching in Step S303, the template region determined in Step S301 may be subjected to image conversion such as change in size or angle, inversion, or binarization. At this time, whether to apply the image conversion to the template region may be selected according to the type of the object to be the target of the task. For example, as described in each of the first to third embodiments, in the case of a task intended for fish, it is conceivable that the size and orientation thereof change in an image. Therefore, by performing the template matching using the template region to which the above-described image conversion is applied, it can be assumed that the similarity is appropriately obtained with respect to the template region. On the other hand, the examples of FIGS. 11 and 12 described in the present embodiment are tasks targeting an artifact in an image captured with a microscope. In such a task, it is considered that there is little change in size and orientation in the image, and thus, when the image conversion as described above is applied, there is a possibility that a high similarity is erroneously acquired in a place different from the assumed place. Therefore, in these examples, it is considered that it is necessary to perform the template matching without applying image conversion to the template region. As described above, when template matching is performed in Step S303, it is preferable to select whether to apply image conversion in consideration of the features of the template region and the image to be compared. At this time, the type of image conversion to be applied may be selected.

After executing the template matching, the learning image generation unit 121 determines whether all the additional candidate images have been selected in Step S302 (Step S304). When all the additional candidate images stored in the additional candidate image storage unit 122 have been selected, the process proceeds to Step S305, and when an unselected additional candidate image remains, the process returns to Step S302. As a result, template matching in Step S303 is performed on each additional candidate image, and as a result, a matching result in each additional candidate image is extracted.

Finally, the learning image generation unit 121 generates a learning image on the basis of each additional candidate image for which template matching has been executed in Step S303 (Step S305). Here, for example, among the matching results in each additional candidate image, an additional candidate image for which a matching result having the highest similarity to the template region is obtained is selected and set as a learning image. This makes it possible to generate a learning image estimated to have a high accuracy improvement effect in machine learning based on the template region determined based on the basis of the basis map. Note that the learning image may be generated using the selected additional candidate image as is, or the learning image may be generated by performing predetermined image processing on the selected additional candidate image.

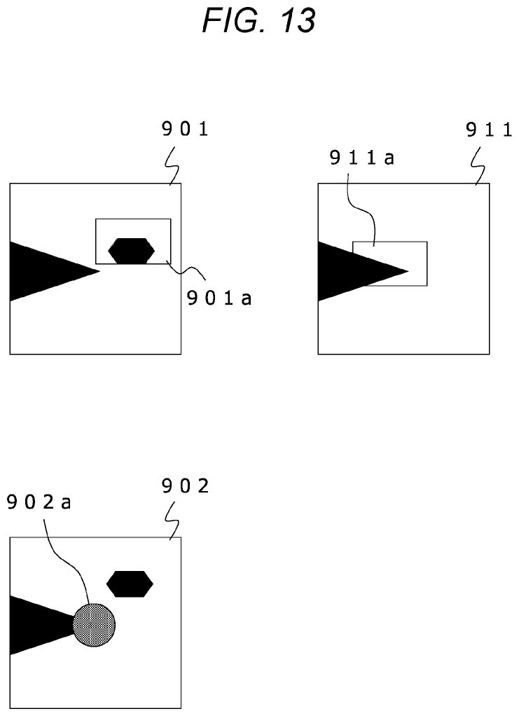

An example of the learning image generation performed in Step S305 will be described with reference to FIG. 13. Here, it is assumed that additional candidate images 901 and 911 are stored in the additional candidate image storage unit 122, and by performing template matching using the template region 805 of FIG. 12 on these additional candidate images 901 and 911, regions 901a and 911a having the highest similarity to the template region 805 in the additional candidate images 901 and 911 are extracted. In the region 901a of the additional candidate image 901, dirt having a shape similar to that of the dirt 711b in the image 711 of FIG. 12 from which the template region 805 is extracted is shown, and thus the similarity is obtained with a relatively high value. On the other hand, no dirt is shown in the additional candidate image 911, and the region 911a having the highest similarity to the template region 805 is extracted therefrom, but the value of the similarity of the region 911a is smaller than that of the region 901a of the additional candidate image 901.

In the situation as described above, when the processing of Step S305 is executed by the learning image generation unit 121, the additional candidate image 901 from which the region 901a is obtained is selected, and a learning image 902 is set on the basis of this. The learning image 902 is generated by superimposing a circle 902a representing an annotation as teacher data on the tip portion of the needle shown in the additional candidate image 901. Note that a background class is set in a portion other than the circle 902a for annotation in the learning image 902.

As described above, in the learning image 902, a portion corresponding to the region 901a in which dirt is captured is set as the background class. Therefore, when machine learning is further performed using the learning image 902 as teacher data and image analysis is performed using a model reflecting the learning result, it is possible to suppress that dirt is erroneously determined as the tip portion of the needle. That is, in the inference result 712 of FIG. 11, it is possible to suppress the circle 712b from being erroneously drawn with respect to the tip portion of the dirt 711b.

In the processing of Step S305, not only the additional candidate image in which the matching result having the highest similarity to the template region is obtained but also a threshold for the matching result may be set, all the additional candidate images in which the similarity to the template region exceeds the threshold may be selected, and the learning image may be generated using these images. In addition, the learning image may be generated on the basis of an additional candidate image that satisfies another condition. For example, it is possible to generate the learning image using the additional candidate image indicating a specific feature such as the value of similarity to the template region significantly deviating from other additional candidate images. Further, the additional candidate image selected on the basis of the result of the template matching may be presented to the user by being displayed on the display apparatus 111 via the output interface 107, and the learning image may be generated using the additional candidate image permitted or designated by the user.

When the generation of the learning image is completed in Step S305, the information processing apparatus 100A of the present embodiment completes the flowchart of FIG. 10.

According to the fourth embodiment of the present invention described above, the information processing apparatus 100A includes the learning image generation unit 121 that extracts a part of the target image as the template region on the basis of the basis map generated by the basis generation unit 105 and generates the learning image used for machine learning on the basis of the extracted template region. With this configuration, it is possible to improve the accuracy of the image analysis processing performed using the machine-learned model using the basis map.

In addition, according to the fourth embodiment of the present invention described above, the basis map indicates the distribution of the basis degrees for the classification result on the target image. The learning image generation unit 121 extracts the template region based on the threshold of the basis degree designated for the basis map (Step S301). With this configuration, an appropriate portion of the target image can be extracted as the template region using the basis map.

Further, according to the fourth embodiment of the present invention described above, the learning image generation unit 121 generates the learning image by extracting a portion in which the similarity to the template region satisfies a predetermined condition from the additional candidate image acquired in advance (Steps S303 and S305). With this configuration, an appropriate learning image can be easily generated on the basis of the template region.

Further, the invention is not limited to the above-described embodiments, and can be changed within a scope not departing from the spirit of the present invention. In addition, the individual embodiment may be implemented alone, or a plurality of arbitrary embodiments may be applied in combination.

What is claimed is:

1. An information processing apparatus comprising:
an analysis target acquisition unit configured to acquire an image to be analyzed;
an image processing unit configured to set a plurality of masks for the image and generate a plurality of masked images by masking each of the images using the plurality of masks;
an inference unit configured to perform inference using a learned model by machine learning for each of the plurality of masked images to acquire an inference result regarding classification of the image for each of the plurality of masked images;
an inference result extraction unit configured to extract an inference result at target coordinates designated in the image from the inference result of each masked image acquired by the inference unit; and
a basis generation unit configured to generate a basis map visualizing a determination basis for a classification result of the image by the model on a basis of the inference result at the target coordinates extracted by the inference result extraction unit and the plurality of masks.

2. The information processing apparatus according to claim 1, wherein
the inference unit acquires, for each of the plurality of masked images, a class representing a classification of the image determined by the inference for each image region as the inference result,
the inference result extraction unit extracts a class of an image region corresponding to the target coordinates among classes for each image region of each masked image acquired by the inference unit, and
the basis generation unit extracts a mask used for generating the masked image as a synthesis target mask for each masked image in which the class extracted by the inference result extraction unit and a target class designated for the image match among the plurality of masked images, generates a synthesis mask image by superimposing and synthesizing the extracted synthesis target masks, and generates the basis map on a basis of the generated synthesis mask image.

3. The information processing apparatus according to claim 2, wherein
the inference unit further acquires a score value representing a reliability of the inference for classification of the image for each class as the inference result for each of the plurality of masked images,
the inference result extraction unit extracts the class and the score value at the target coordinates of each masked image, and
the basis generation unit superimposes and synthesizes each synthesis target mask at a ratio according to the score value extracted by the inference result extraction unit to generate the synthesis mask image.

4. The information processing apparatus according to claim 1, wherein
the inference unit acquires, for each of the plurality of masked images, a score value representing a reliability of the inference for classification of the image for each image region as the inference result,
the inference result extraction unit extracts a score value of an image region corresponding to the target coordinates among score values for each image region of each masked image acquired by the inference unit, and
the basis generation unit generates a synthesis mask image by superimposing and synthesizing the plurality of masks at a ratio according to the score value extracted by the inference result extraction unit, and generates the basis map on a basis of the generated synthesis mask image.

5. The information processing apparatus according to claim 1, comprising a learning image generation unit configured to extract a part of the image as a template region on a basis of the basis map, and generate a learning image used for the machine learning on a basis of the extracted template region.

6. The information processing apparatus according to claim 5, wherein
the basis map indicates a distribution of basis degrees for the classification result on the image, and
the learning image generation unit extracts the template region on a basis of a threshold of the basis degree designated for the basis map.

7. The information processing apparatus according to claim 5, wherein the learning image generation unit generates the learning image by extracting a portion in which a similarity to the template region satisfies a predetermined condition from an additional candidate image acquired in advance.

8. The information processing apparatus according to claim 1, comprising an input interface configured to receive a user's input operation,
wherein the analysis target acquisition unit acquires the target coordinates on a basis of the user's input operation performed via the input interface.

9. The information processing apparatus according to claim 1, comprising an output interface that is connected to a display apparatus and provides information to a user by causing the display apparatus to display the basis map.

10. The information processing apparatus according to claim 9, wherein the output interface causes the display apparatus to display a screen in which the basis map is superimposed on the image.

11. The information processing apparatus according to claim 1, comprising an external interface that is connected to an external information device,
wherein the analysis target acquisition unit acquires the target coordinates via the external interface.

12. The information processing apparatus according to claim 1, wherein the image processing unit adjusts at least one of a position, a shape, and a density of the plurality of masks set for the image on a basis of the target coordinates or other coordinates designated in the image.

13. The information processing apparatus according to claim 1, wherein the image processing unit generates the masked image by using an unmasked portion of the image as is, and performs predetermined image processing on a masked portion of the image to generate the masked image.

14. The information processing apparatus according to claim 1, wherein the analysis target acquisition unit acquires an image captured by an electron microscope as the image to be analyzed.

15. An image processing method using an information processing apparatus, comprising:
acquiring an image to be analyzed;
setting a plurality of masks for the image;
generating a plurality of masked images by masking each of the images using the plurality of masks;
acquiring, for each of the plurality of masked images, an inference result regarding classification of the image for each of the plurality of masked images by performing inference using a learned model by machine learning;
extracting an inference result at target coordinates designated in the image from an inference result of each acquired masked image; and
generating a basis map visualizing a determination basis for a classification result of the image by the model on a basis of the extracted inference result at the target coordinates and the plurality of masks.
